(19) United States
(12) Patent Application Publication
(10) Pub. No.: US 2010/0319657 A1
(43) Pub. Date: Dec. 23, 2010

(54) METHOD AND SYSTEM FOR SINGLE EXHAUST VALVE BRIDGE BRAKE

(75) Inventors: Sotir Dodi, Windsor, CT (US); Brian L. Ruggiero, East Granby, CT (US)

Correspondence Address: KELLEY DRYE & WARREN LLP, 3050 K STREET, NW, SUITE 400, WASHINGTON, DC, 20007, US

(73) Assignee: Jacobs Vehicle Systems, Inc., Bloomfield, CT (US)

(21) Appl. No.: 12/792,654

(22) Filed: Jun. 2, 2010

Related U.S. Application Data
(60) Provisional application No. 61/183,385, filed on Jun. 2, 2009.

(51) Int. Cl. F02D 13/04

(52) U.S. Cl. 123/321

(57) ABSTRACT

Systems and methods for providing compression-release and partial bleeder braking engine valve actuation are disclosed. In an embodiment of the present invention, a cam may be provided with a main exhaust lobe and a compression-release or partial bleeder lobe and a base circle portion between the two lobes. A rocker arm including an internal rocker passage may be operatively connected to the cam. The rocker arm may contact a valve bridge at a central portion. The valve bridge may be operatively connected to first and second engine valves at its first and second ends, respectively. A slave piston incorporated into the first end of the valve bridge and a master piston may be incorporated into the central portion of the valve bridge. A hydraulic circuit may be provided between the master and slave pistons. The master and slave pistons may be selectively actuated and the bleed hole may be selectively blocked and unblocked to provide compression-release or partial bleeder braking as a result of the valve actuation motion imparted from the cam to the valve bridge through the rocker arm.

### FIELD OF THE INVENTION

The present invention relates systems for, and methods of producing engine braking events in an internal combustion engine. In particular, the present invention relates to engine braking systems and methods for producing compression-release and bleeder, including partial-cycle bleeder, engine braking valve events.

### BACKGROUND OF THE INVENTION

Flow control of exhaust gas through an internal combustion engine has been used in order to provide vehicle engine braking. Generally, engine braking systems may control the flow of exhaust gas from the engine cylinders to the exhaust system (i.e., exhaust manifold, tail pipe, etc.). The flow of exhaust gas from the engine cylinders may be controlled to provide a retarding force on the engine pistons to slow the engine. Specifically, one or more exhaust valves may be selectively actuated to provide compression-release, bleeder, and/or partial bleeder engine braking.

The operation of a compression-release type engine brake, or retarder, is well known. A four-stroke internal combustion engine experiences intake, compression, expansion, and exhaust cycles during its operation. The intake cycle occurs in conjunction with a main intake valve event, during which the intake valves in each cylinder are opened to allow air to enter the cylinder. The exhaust cycle occurs in conjunction with a main exhaust valve event, during which the exhaust valves in each cylinder are opened to allow combustion gases to exit the cylinder. Typically, the exhaust and intake valves are closed during much of the compression and expansion cycles. During compression-release engine braking, fuel supply to the engine cylinders is ceased and, in addition to the main exhaust valve event, one or more exhaust valves also may be selectively opened during the compression stroke to convert the internal combustion engine into a power absorbing air compressor. Specifically, as an engine piston travels upward during the compression stroke, the gases trapped in the cylinder are compressed and oppose the upward motion of the piston. As the piston approaches the top dead center (TDC) position during the compression stroke at least one exhaust valve may be opened to release the compressed gases in the cylinder to the exhaust manifold, preventing the energy stored in the compressed gases from being returned to the piston on the subsequent expansion down-stroke. In doing so, the engine develops retarding power to help slow the vehicle down. An example of a prior art compression release engine brake is provided by the disclosure of Cummins, U.S. Pat. No. 3,220,392 (November 1965), which is hereby incorporated by reference.

The operation of a bleeder type engine brake is also known. During bleeder engine braking, in addition to the main exhaust valve event, one or more exhaust valve(s) may be held slightly open throughout the remaining engine cycles (i.e., the intake, compression, and expansion cycles for a full-cycle bleeder brake) or during a portion of the remaining engine cycles (i.e., the compression and expansion cycles for a partial-cycle bleeder brake). The primary difference between a partial-cycle bleeder brake and a full-cycle bleeder brake is that the former may permit the exhaust valve to close during most or all of the intake cycle. An example of a bleeder engine brake is disclosed in Yang, U.S. Pat. No. 6,594,996 (Jul. 22, 2003), which is hereby incorporated by reference.

The initial opening of the exhaust valves in a bleeder braking operation may be in advance of TDC of the compression stroke, and is preferably near a bottom dead center (BDC) point between the intake and compression cycles. As such, a bleeder type engine brake may require much lower force to actuate the valves, and generate less noise due to continuous bleeding instead of the rapid blow-down of a compression-release type brake. Thus, an engine bleeder brake can have significant advantages.

### BRIEF SUMMARY OF THE INVENTION

In connection with an embodiment of the present invention, Applicant has developed an innovative system for providing compression-release engine braking, comprising: a cam having a main exhaust lobe and a compression-release lobe; a rocker arm operatively connected to the cam, said rocker arm including an internal rocker passage; a valve bridge having a central portion positioned adjacent to the rocker arm, and having first and second ends operatively connected to first and second engine valves, respectively; a slave piston incorporated into the first end of the valve bridge; and a master piston incorporated into the central portion of the valve bridge.

In connection with another embodiment of the present invention, Applicant has developed an innovative system for providing compression-release engine braking operation in an internal combustion engine, comprising: a cam including a compression-release lobe; a valve bridge operatively connected to the cam, said valve bridge having first and second ends operatively connected to first and second engine valves, respectively; a slave piston slidably disposed in a slave piston bore incorporated into the first end of the valve bridge; a master piston incorporated into the central portion of the valve bridge; a bleed hole extending from the slave piston bore to an outer surface of the valve bridge; and a means for selectively blocking the bleed hole.

In connection with yet another embodiment of the present invention, Applicant has developed an innovative system for providing partial bleeder engine braking, comprising: a cam having a main exhaust lobe and a partial bleeder braking lobe; a rocker arm operatively connected to the cam, said rocker arm including an internal rocker passage; a valve bridge having a central portion positioned adjacent to the rocker arm, and having first and second ends operatively connected to first and second engine valves, respectively; a slave piston incorporated into the first end of the valve bridge; a master piston incorporated into the central portion of the valve bridge; an accumulator bore provided in the valve bridge; a hydraulic passage extending between the accumulator bore and the master piston; an accumulator piston slidably disposed in the accumulator bore; and an accumulator spring biasing the accumulator piston into the accumulator bore.

It is to be understood that both the foregoing general description and the following detailed description are exemplary and explanatory only, and are not restrictive of the invention as claimed. The accompanying drawings, which are incorporated herein by reference, and which constitute a part of this specification, illustrate certain embodiments of the invention and, together with the detailed description, serve to explain the principles of the present invention.

### BRIEF DESCRIPTION OF THE DRAWINGS

The present invention will now be described in connection with the following figures in which like reference characters refer to like elements and wherein:

FIG. 1 is a side view in partial cross-section illustrating a system for providing compression-release engine braking in accordance with an embodiment of the present invention.

FIG. 2 is a side view in partial cross-section illustrating a system for providing compression-release engine braking in accordance with a second embodiment of the present invention.

FIG. 3 illustrates the control valve shown in section A-A in FIG. 2.

FIG. 4 a top view in cross-section illustrating a rocker arm of the type shown in FIGS. 1 and 2 mounted on a rocker shaft and in communication with a hydraulic control valve.

FIG. 5 is an alternative cam for use with the embodiment of the invention shown in FIG. 2.

### DETAILED DESCRIPTION OF THE INVENTION

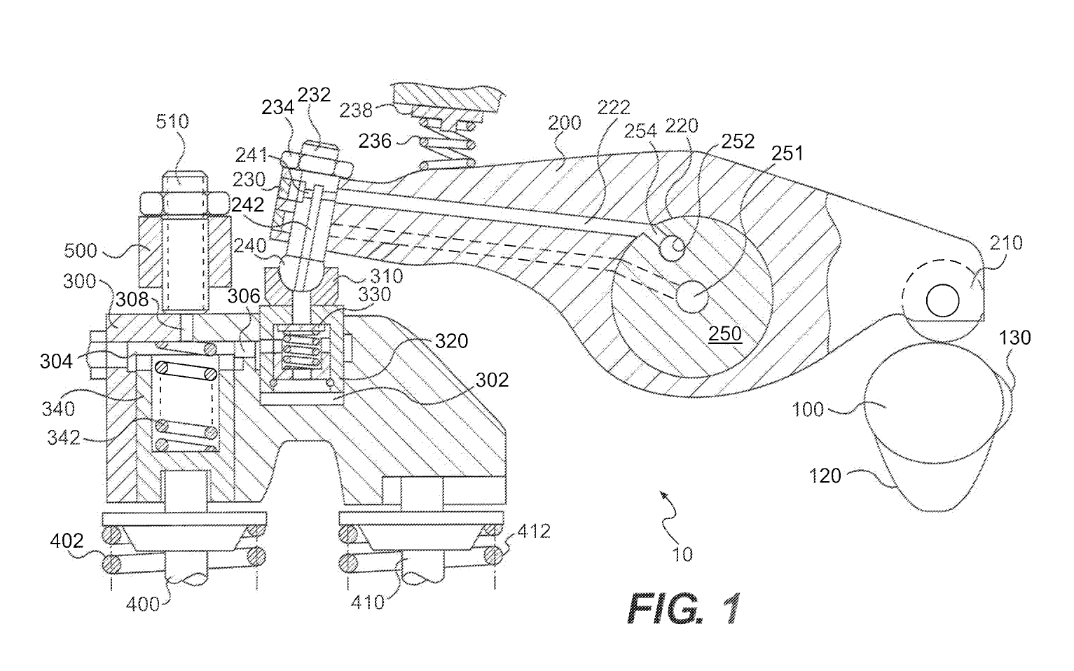

Reference will now be made in detail to a first embodiment of the present invention, an example of which is illustrated as valve actuation system 10 in FIG. 1 of the accompanying drawings. The valve actuation system 10 may include a cam 100, a rocker arm 200, a valve bridge 300, and a bracket or fixed member 500, which collectively are used to actuate the engine valves 400.

The cam 100 shown in FIG. 1 may rotate clockwise once for each set of four engine cycles. The cam 100 may include a compression-release braking lobe 130 and a main exhaust lobe 120. A base circle portion may be provided between the compression-release braking lobe 130 and the main exhaust lobe 120. The compression-release braking lobe 130 may have a predetermined height, which pivots the second end 230 of the rocker arm 200 an amount which is capable of being absorbed by the travel of the master piston 320. The cam 100 is located next to, and may selectively or continuously contact, the cam roller 210 or other contact surface of the rocker arm 200.

The rocker arm 200 may include a central bore 220, the cam roller 210 at a first end, and an elephant foot 240 at a second end 230. A rocker passage 222 may extend from the central bore 220 to the second end 230 of the rocker arm. The rocker passage 222 may be sealed shut at its outer end by a plug 224. The elephant foot 240 may incorporate an adjustment screw 232 at an upper end which may be fixed in place by a locking nut 234. The position of the elephant foot 240 relative to the rocker arm 200 may be adjusted by screwing the elephant foot into or out of the second end 230 of the rocker arm.

The central portion of the elephant foot 240 may include an annular indentation and one or more transverse passages 241 extending through the elephant foot in the region of the annular indentation. The one or more transverse passages 241 may communicate with a longitudinal passage 242 extending through the interior of the elephant foot 240 from its central portion to a lower portion. The annular indentation and the one or more transverse passages 241 in the central portion of the elephant foot may permit hydraulic fluid flow between the rocker passage 222 and the longitudinal passage 242 without regard to the orientation of the elephant foot 240 in the second end 230 of the rocker arm. As a result the elephant foot 240 may be screwed into or out of the rocker arm 200 without fear of interfering with the hydraulic communication between the rocker passage 222 and the longitudinal passage 242.

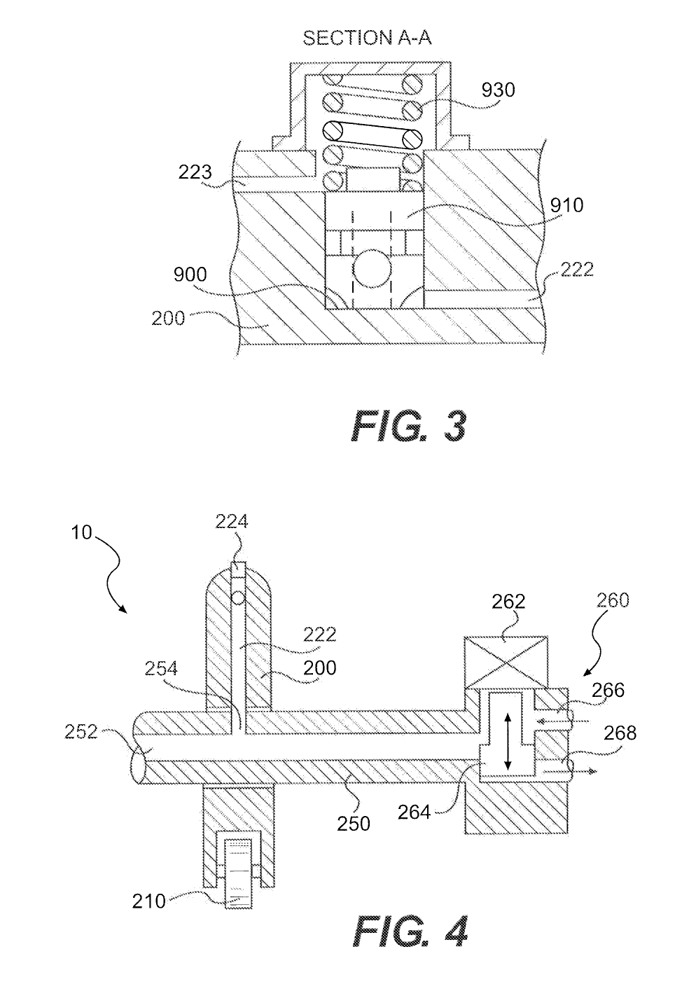

The rocker arm 200 may be pivotally mounted on a rocker shaft 250 extending through the central bore 220. The rocker shaft 250 may include a central supply passage 252 which may be substantially co-extensive and co-linear with the rocker shaft. A second hydraulic passage 254 may connect the supply passage 252 with the portion of the rocker passage 222 communicating with the central bore 220. The supply passage 252 may be connected to a low pressure hydraulic fluid source, such as a lube oil source (not shown), by a control valve (shown in FIG. 3 and explained below). The control valve 260 may be used to supply and drain hydraulic fluid to and from the supply passage 252.

The rocker passage 222 may register with the second hydraulic passage 254 when the base circle portion of the cam 100 is contacting the cam roller 210. The rocker passage 222 may be sized at the end that meets the central bore 220 such that rotation of the rocker arm 200 resulting from the main exhaust lobe 120 prevents the second hydraulic passage 254 from registering with the rocker passage 222 and thereby blocks the flow of hydraulic fluid to the rocker passage. The rocker passage 222 may also be sized at the end that meets the central bore 220 such that rotation of the rocker arm 200 resulting from the compression-release lobe 130 maintains registration between the second hydraulic passage 254 and the rocker passage 222 and thereby maintains the flow of hydraulic fluid to the rocker passage through out the compression-release motion.

With renewed reference to FIG. 1, the valve bridge 300 may be disposed between the elephant foot 240 and the engine valves 400 and 410, which are preferably exhaust valves. The engine valve springs 402 and 412 may bias the engine valves 400 and 410 upward against their seats and may bias the rocker arm 200 towards and into contact with the cam 100. At the same time, the rocker spring 236 may bias the rocker arm 200 and elephant foot 240 downward into contact with the valve bridge 300 through a master piston 320. The biasing force exerted on the rocker arm 200 by the rocker spring 236 may be large enough to prevent any “no-follows” by the valve train components, but less than the force exerted on the master piston 320 by the low pressure hydraulic fluid source connected to the supply passage 252. As a result, the elephant foot 240 may be biased into contact with the valve bridge 300 through a master piston 320.

The master piston 320 may be slideably disposed in a master piston bore 302 located in the center of the valve bridge 300. A slave piston 340 may be slideably disposed in a slave piston bore 304 located over the first engine valve 400. A bridge passage 306 may extend through the interior of the valve bridge 300 and provide hydraulic communication between the master piston bore 302 and the slave piston bore 304. A first check valve 330 may be disposed in the hydraulic circuit extending between the master piston 320 and the slave piston 340. A bleed hole 308 may extend from the upper end of the slave piston bore 304 to the outer surface of the valve bridge 300.

A concave member 310 may be disposed between the master piston 320 and the elephant foot 240 to assist in reducing the application of transverse loads on the master piston when the elephant foot presses down and pivots against the master piston 320 and the valve bridge 300. The concave member 310 may have an upper surface adapted to receive the rounded bottom of the elephant foot 240 and further include a central opening adapted to permit hydraulic fluid to flow through it to the master piston. The concave member 310 may permit the elephant foot 240 to maintain a fluid tight seal with, and provide hydraulic fluid to, the master piston 320 and ultimately the interior of the valve bridge 300 while the rocker arm 200 and elephant foot 240 pivot back and forth about the rocker shaft 250.

The master piston 320 may include a central passage adapted to permit hydraulic fluid to pass into the master piston bore 302 from the hydraulic passages in the concave member 310, the elephant foot 240, and the rocker arm 200. Hydraulic flow out of the master piston bore 302 may be prevented by placement of the first check valve 330 inside the master piston 320. The first check valve 330 may permit hydraulic fluid to flow into the interior of the valve bridge 300, but substantially prevent back flow of hydraulic fluid from the valve bridge to the elephant foot 240. The first check valve 330 is shown as a spring biased check disc, however, it is appreciated that any type of check valve may be used in alternative embodiments of the present invention.

The slave piston 340 may include a stepped or chamfered upper surface adapted to permit hydraulic fluid to work against the slave piston upper surface, or as shown in FIG. 1, a hollow interior adapted for the same purpose. A spring 342 may be disposed in the hollow interior of the slave piston 340. The slave piston 340 may be biased towards the exhaust valve 400 out of the slave piston bore 304 by the spring 342.

A brake load screw 510 may be held in place by a bracket or fixed member 500 otherwise connected to the engine or engine compartment. The upper surface of the valve bridge 300 in the region of the bleed hole 308 may be adapted to seat against the brake load screw 510 such that when so seated hydraulic fluid is blocked from venting through the bleed hole 308. It is appreciated that the mating surfaces of the brake load screw 510 and the valve bridge 300 may be specially finished or shaped to provide a sufficiently fluid tight seal between them. It is appreciated that other types of sealing may be used to prevent hydraulic fluid flow out of the bleed hole 308 in alternative embodiments of the present invention. The position of the brake load screw 510 may be adjusted and locked by a locking nut so that the valve bridge 300 just contacts the brake load screw when the first and second engine valves 400 and 410 are closed.

When the engine valves 400 and 410 are exhaust valves, the system 10 shown in FIG. 1 may be used as follows to provide (i) main exhaust valve actuation during positive power operation of the engine and (ii) compression-release braking valve actuation during an engine braking mode of operation. With reference to FIG. 4, during positive power operation the control piston 264 may be moved such that hydraulic fluid is free to vent from the supply passage 252 through the second fluid port 268. At the same time, fluid flow into the supply passage 252 from the first fluid port 266 is blocked by the control piston 264, and no hydraulic fluid is supplied to the rocker arm 200 passage 222 or the bridge 300. Because the rocker arm 200, elephant foot 240, and bridge 300, do not contain any sufficiently pressurized hydraulic fluid, the rocker spring 236 may force the rocker arm 200, elephant foot 240, and master piston 320 downward (counter-clockwise in FIG. 1) until the master piston is at its most recessed position relative to the bridge 300. As a result, a lash space may be provided between the cam roller 210 and the cam 100 during positive power operation of the engine as shown in FIG. 1.

Rotation of the cam 100 during positive power operation results in motion being imparted to the rocker arm 200 only by the main exhaust lobe 120. Motion from the main exhaust lobe 120 pivots the rocker arm 200 about the rocker shaft 250 which forces the valve bridge 300 downward and opens both of the engine valves 400 and 410. During this process, the slave piston 340 may remain seated against the interior end wall of the slave piston bore 304 because there is no pressurized hydraulic fluid contained in the slave piston bore. Valve opening motion that could potentially be imparted to the rocker arm by the compression-release lobe 130 during positive power operation may be “lost” as a result of the relative equivalence of the height of the lash space between the cam roller 210 and the cam 100 and the height of the compression-release lobe.

An engine braking mode of operation may be initiated by sending a control signal to the control valve 260 causing the control piston 264 to move (into a fully open position as shown in FIG. 4) and block hydraulic fluid flow through the second fluid port 268 thereby preventing further hydraulic fluid from venting from the system. At the same time, fluid flow from the fluid supply (not shown) through the first fluid port 266 into the supply passage 252 is permitted by the control piston 264. As a result, hydraulic fluid is supplied to the rocker arm 200 through the supply passage 252 and the second hydraulic passage 254.

Hydraulic fluid flows through the rocker passage 222, the transverse passage(s) 241, longitudinal passage 242, and into the interior of the valve bridge 300. Hydraulic fluid enters the valve bridge and fills the master piston bore 302, the slave piston bore 304 and the bridge passage 306. The hydraulic fluid in the valve bridge is of sufficient pressure to overcome the downward bias of the rocker spring 236 and push the master piston 320 upward. As the master piston 320 rises out of the master piston bore 302, the rocker arm 200 pivots clockwise relative to the rocker shaft 250. As the rocker arm pivots, the lash space between the cam 100 and the cam roller 210 is taken up until the rocker arm 200 contacts the base circle portion of the cam 100. The supply of hydraulic fluid to the slave piston 340 may push the valve bridge 300 upward against the brake load screw 510.

After the rocker arm 200 contacts the base circle portion of the cam 100, continued rotation of the cam causes the rocker arm to begin to pivot counter-clockwise as it begins to encounter the compression-release lobe 130. The counter-clockwise rotation of the rocker arm 200 is opposed by the valve closing bias of the first and second engine valve springs 402 and 412 which act on the rocker arm through the hydraulic fluid pressure in the circuit connecting the master piston 320 and the slave piston 340.

The compression-release lobe 130 may be provided on the cam 100 such that the compression-release event begins near the end of the compression stroke of the engine cylinder for which engine braking is desired. As the compression-release lobe 130 pivots the rocker arm 200 counter-clockwise, the master piston 320 may displace hydraulic fluid trapped in the valve bridge and push the slave piston 340 downward to open the engine valve 400 against the bias of the valve spring 402 and the force acting on the engine valve 400 by cylinder pressure. The master piston 320 may be designed so that it is fully extended into and contacts the end wall of the master piston bore 302 when the rocker arm 200 is pivoted a distance equal to the height of the compression-release lobe 130.

No significant amount of hydraulic fluid may escape through the bleeding hole 308 during the compression-release event because the valve bridge 300 remains seated against the brake load screw 510 throughout it. The small opening of the engine valve 400 by the slave piston 340 may produce compression-release type engine braking. The braking load over the slave piston 340 during the compression stroke of the engine cylinder may be transferred to the brake load screw 510 through the hydraulic fluid pressure in the slave piston bore 304. As a result, the braking load need not be transferred back through the valve train to the master piston 320, the rocker arm 200, or the cam 100. The cam 100 continues to rotate through the compression-release event during engine braking operation until the main exhaust lobe 120 reaches the cam roller 210 causing the rocker arm to pivot beyond the displacement produced by the compression-release lobe 130. The downward displacement of rocker arm 200 against the master piston 320 may no longer be hydraulically transferred to the slave piston 340 because the master piston may be contacting the end wall of the master piston bore 302 at this point. As a result, the downward displacement of the rocker arm 200 from the main exhaust lobe 120 may be transmitted mechanically from the master piston 320 to the valve bridge 300, which in turn may translate downward and open the first and second engine valves 400 and 410 for the main exhaust event.

The first engine valve 400 is already open when the second engine valve 410 first begins to open for the main exhaust event. As the valve bridge 300 moves downward for the main exhaust event it may pull away from the brake load screw 510 and uncover the bleed hole 308. Pressurized hydraulic fluid in the slave piston bore 304 may then escape through the bleed hole 308 and allow the slave piston 340 to move upward relative to the downward motion of the valve bridge 300 until the slave piston 340 resets against the end wall of the slave piston bore 304. The main exhaust event may then be completed by the valve bridge 300 acting on each of the engine valves 400 and 410 mechanically.

After the main exhaust lobe 120 reaches its maximum height, the rocker arm 200 pivots clock-wise until the cam roller 210 is contacting the base circle of the cam. As the rocker arm pivots back during the later portion of the main exhaust event, the engine valves may close against their seats and the valve bridge 300 may come to a rest. Thereafter hydraulic fluid may force the master piston 320 upward again to refill the master piston bore 302 so that the cycle of compression-release braking and main exhaust valve actuation is repeated as describe above.

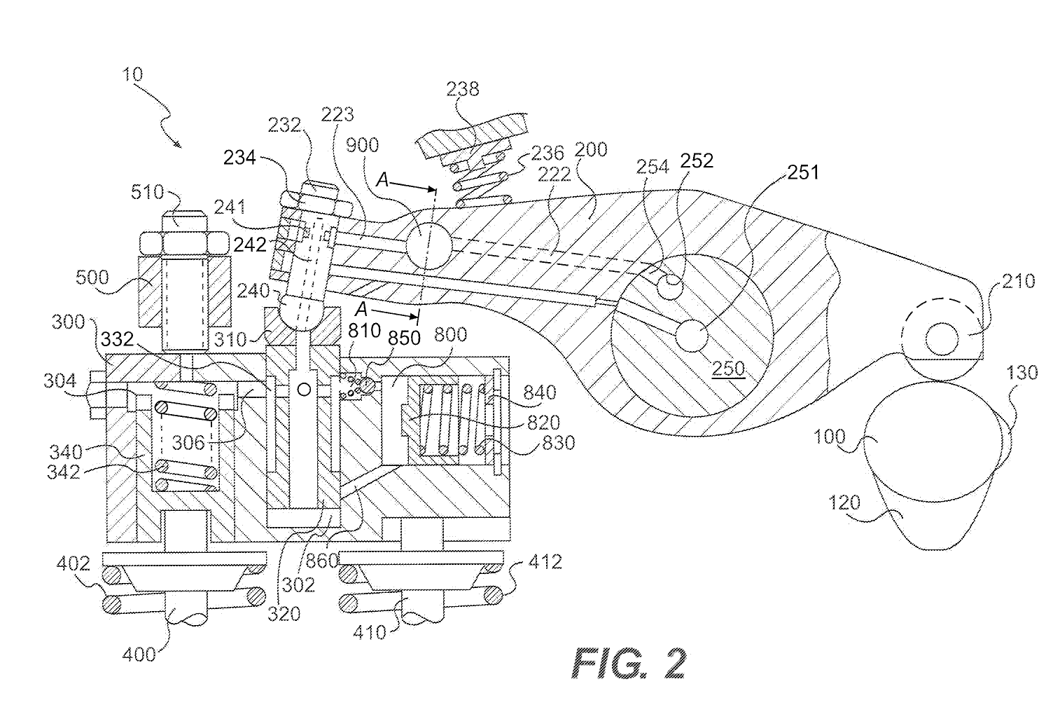

Reference will now be made in detail to a third embodiment of the present invention, an example of which is illustrated as valve actuation system 10 in FIG. 2 of the accompanying drawings. The valve actuation system 10 may include a cam 100, a rocker arm 200, a valve bridge 300, and a bracket or fixed member 500, which collectively are used to actuate the engine valves 400.

The cam 100 shown in FIG. 1 may rotate clockwise once for each set of four engine cycles. The cam 100 may include a compression-release braking lobe 130 and a main exhaust lobe 120. A base circle portion may be provided between the compression-release braking lobe and the main exhaust lobe. The compression-release braking lobe 130 may have a predetermined height, which pivots the second end 230 of the rocker arm 200 an amount which is capable of being absorbed by the travel of the master piston 320. The cam 100 is located next to, and may selectively or continuously contact, the cam roller 210 of the rocker arm 200.

The rocker arm 200 may include a central bore 220, the cam roller 210 at a first end, and an elephant foot 240 at a second end 230. A rocker passage 222/223 may extend from the central bore 220 to the second end 230 of the rocker arm. The rocker passage 222/223 may be sealed shut at its outer end by a plug 224. The elephant foot 240 may incorporate an adjustment screw 232 at an upper end which may be fixed in place by a locking nut 234. The position of the elephant foot 240 relative to the rocker arm 200 may be adjusted by screwing the elephant foot into or out of the second end 230 of the rocker arm.

The central portion of the elephant foot 240 may include an annular indentation and one or more transverse passages 241 extending through the elephant foot in the region of the annular indentation. The one or more transverse passages 241 may communicate with a longitudinal passage 242 extending through the interior of the elephant foot 240 from its central portion to a lower portion. The annular indentation and the one or more transverse passages 241 in the central portion of the elephant foot may permit hydraulic fluid flow between the rocker passage 222/223 and the longitudinal passage 242 without regard to the orientation of the elephant foot 240 in the second end 230 of the rocker arm. As a result the elephant foot 240 may be screwed into or out of the rocker arm 200 without fear of interfering with the hydraulic communication between the rocker passage 222/223 and the longitudinal passage 242.

The rocker arm 200 may be pivotally mounted on a rocker shaft 250 extending through the central bore 220. The rocker shaft 250 may include a central supply passage 252 which may be substantially co-extensive and co-linear with the rocker shaft. A second hydraulic passage 254 may connect the supply passage 252 with the portion of the first and second rocker passages 222 and 223 communicating with the central bore 220. The supply passage 252 may be connected to a low pressure hydraulic fluid source, such as a lube oil source (not shown), by a control valve (shown in FIG. 4 and explained below). The control valve 260 (FIG. 3) may be used to supply and drain hydraulic fluid to and from the supply passage 252.

The rocker passage 222 may register with the second hydraulic passage 254 when the base circle portion of the cam 100 is contacting the cam roller 210. The rocker passage 222 may be sized at the end that meets the central bore 220 such that rotation of the rocker arm 200 resulting from the main exhaust lobe 120 prevents the second hydraulic passage 254 from registering with the rocker passage 222 and thereby blocks the flow of hydraulic fluid to the rocker passage. The rocker passage 222 may also be sized at the end that meets the central bore 220 such that rotation of the rocker arm 200 resulting from the compression-release lobe 130 maintains registration between the second hydraulic passage 254 and the rocker passage 222 and thereby maintains the flow of hydraulic fluid to the rocker passage through out the compression-release motion.

With reference to FIGS. 2 and 3, a control valve bore 900 may be provided in the rocker arm 200. A control valve piston 910 may be biased by a control valve spring 930 into the control valve bore. A check valve may be provided within the control valve piston 910 such that the application of hydraulic fluid to the control valve piston indexes the piston and permits a high pressure hydraulic circuit to be maintained between the control valve piston and the slave piston 340.

With continued reference to FIG. 2, the valve bridge 300 may be disposed between the elephant foot 240 and the engine valves 400 and 410, which are preferably exhaust valves. The engine valve springs 402 and 412 may bias the engine valves 400 and 410 upward against their seats and may bias the rocker arm 200 towards and into contact with the cam 100. At the same time, the rocker spring 236 may bias the rocker arm 200 and elephant foot 240 downward into contact with the valve bridge 300 through a master piston 320. The biasing force exerted on the rocker arm 200 by the rocker spring 236 may be large enough to prevent any “no-follows” by the valve train components, but less than the force exerted on the master piston 320 by the low pressure hydraulic fluid source connected to the supply passage 252. As a result, the elephant foot 240 may be biased into contact with the valve bridge 300 through a master piston 320.

The master piston 320 may be slidably disposed in a master piston bore 302 located in the center of the valve bridge 300. The master piston 320 may include an annular recess 332 which is adapted to selectively register with an accumulator vent passage 860 when the master piston travels downward for a compression-release event. A slave piston 340 may be slidably disposed in a slave piston bore 304 located over the first engine valve 400. A bridge passage 306 may extend through the interior of the valve bridge 300 and provide hydraulic communication between the master piston bore 302 and the slave piston bore 304.

An accumulator bore 800 may be provided in the valve bridge 300. An accumulator piston 820 may be slidably disposed in the accumulator bore, and a connecting passage may extend between the accumulator bore and the master piston bore 800. An accumulator spring 830 may bias the accumulator piston into its bore. A retaining ring 840 may provide a surface against which the accumulator spring may act. A check valve 810 may be disposed in the connecting passage extending between the master piston bore 302 and the accumulator bore 800. The check valve 810 may permit one-way fluid flow from the accumulator bore to the master piston bore.

A concave member 310 may be disposed between the master piston 320 and the elephant foot 240 to assist in reducing the application of transverse loads on the master piston when the elephant foot presses down and pivots against the master piston 320 and the valve bridge 300. The concave member 310 may have an upper surface adapted to receive the rounded bottom of the elephant foot 240 and further include a central opening adapted to permit hydraulic fluid to flow through it to the master piston. The concave member 310 may permit the elephant foot 240 to maintain a fluid tight seal with, and provide hydraulic fluid to, the master piston 320 and ultimately the interior of the valve bridge 300 while the rocker arm 200 and elephant foot 240 pivot back and forth about the rocker shaft 250.

The master piston 320 may include a central passage adapted to permit hydraulic fluid to pass into the master piston bore 302 from the hydraulic passages in the concave member 310, the elephant foot 240, and the rocker arm 200. The check valve 810 and the check valve in the control valve piston 910 may permit hydraulic fluid to flow into the interior of the valve bridge 300, but substantially prevent back flow of hydraulic fluid from the valve bridge to the elephant foot 240 or to the accumulator until after the master piston 330 has provided a complete compression-release event.

The slave piston 340 may include a stepped or chamfered upper surface adapted to permit hydraulic fluid to work against the slave piston upper surface, or as shown in FIG. 2, a hollow interior adapted for the same purpose. A spring 342 may be disposed in the hollow interior of the slave piston 340. The slave piston 340 may be biased towards the exhaust valve 400 out of the slave piston bore 304 by the spring 342.

A brake load screw 510 may be held in place by a bracket or fixed member 500 otherwise connected to the engine or engine compartment. The upper surface of the valve bridge 300 may be adapted to seat against the brake load screw 510. The position of the brake load screw 510 may be adjusted and locked by a locking nut so that the valve bridge 300 just contacts the brake load screw when the first and second engine valves 400 and 410 are closed.

When the engine valves 400 and 410 are exhaust valves, the system 10 shown in FIG. 2 may be used as follows to provide (i) main exhaust valve actuation during positive power operation of the engine and (ii) compression-release braking valve actuation during an engine braking mode of operation. With reference to FIG. 4, during positive power operation the control piston 264 may be moved such that hydraulic fluid is free to vent from the supply passage 252 through the second fluid port 268. At the same time, fluid flow into the supply passage 252 from the first fluid port 266 is blocked by the control piston 264, and no hydraulic fluid is supplied to the rocker arm 200 passage 222 or the bridge 300. Because the rocker arm 200, elephant foot 240, and bridge 300, do not contain any sufficiently pressurized hydraulic fluid, the rocker spring 236 may force the rocker arm 200, elephant foot 240, and master piston 320 downward (counter-clockwise in FIG. 2) until the master piston is at its most recessed position relative to the bridge 300. As a result, a lash space is provided between the cam roller 210 and the cam 100 during positive power operation of the engine as shown in FIG. 2.

Rotation of the cam 100 during positive power operation results in motion being imparted to the rocker arm 200 only by the main exhaust lobe 120. Motion from the main exhaust lobe 120 pivots the rocker arm 200 about the rocker shaft 250 which forces the valve bridge 300 downward and opens both of the engine valves 400 and 410. During this process, the slave piston 340 may remain seated against the interior end wall of the slave piston bore 304 because there is no pressurized hydraulic fluid contained in the slave piston bore. Valve opening motion that could potentially be imparted to the rocker arm by the compression-release lobe 130 during positive power operation may be “lost” as a result of the relative equivalence of the height of the lash space between the cam roller 210 and the cam 100 and the height of the compression-release lobe.

An engine braking mode of operation may be initiated by sending a control signal to the control valve 260 causing the control piston 264 to move (into a fully open position as shown in FIG. 4) and block hydraulic fluid flow through the second fluid port 268 thereby preventing further hydraulic fluid from venting from the system. At the same time, fluid flow from the fluid supply (not shown) through the first fluid port 266 into the supply passage 252 is permitted by the control piston 264. As a result, hydraulic fluid is supplied to the rocker arm 200 through the supply passage 252 and the second hydraulic passage 254.

Hydraulic fluid flows through the first rocker passage 222, indexes the control valve piston 910, flows through the second rocker passage 223, the transverse passage(s) 241, longitudinal passage 242, and into the interior of the valve bridge 300. Hydraulic fluid enters the valve bridge and fills the master piston bore 302, the slave piston bore 304 and the bridge passage 306. The hydraulic fluid in the valve bridge is of sufficient pressure to overcome the downward bias of the rocker spring 236 and push the master piston 320 upward when the cam 100 is at base circle. As the master piston 320 rises out of the master piston bore 302, the rocker arm 200 pivots clockwise relative to the rocker shaft 250. As the rocker arm pivots, the lash space is taken up until the rocker arm 200 contacts the base circle portion of the cam 100. The supply of hydraulic fluid to the slave piston 340 may push the valve bridge 300 upward against the brake load screw 510.

After the rocker arm 200 contacts the base circle portion of the cam 100, continued rotation of the cam causes the rocker arm to begin to pivot counter-clockwise as it begins to encounter the compression-release lobe 130. The counter-clockwise rotation of the rocker arm 200 is opposed by the valve closing bias of the first and second engine valve springs 402 and 412 which act on the rocker arm through the hydraulic fluid pressure in the circuit connecting the master piston 320 and the slave piston 340.

The compression-release lobe 130 may be provided on the cam 100 such that the compression-release event begins near the end of the compression stroke of the engine cylinder for which engine braking is desired. As the compression-release lobe 130 pivots the rocker arm 200 counter-clockwise, the master piston 320 may displace hydraulic fluid trapped in the valve bridge and push the slave piston 340 downward to open the engine valve 400 against the bias of the valve spring 402 and the force acting on the engine valve 400 by cylinder pressure. The master piston 320 may be designed so that the annular recess 332 registers with the accumulator vent passage 860 when the compression release event has reached the maximum lift, i.e., after the rocker arm is pivoted a distance equal to the height of the compression-release lobe 130. At this point, the fluid pressure in the hydraulic circuit formed between the master piston and the slave piston may vent through the accumulator vent passage 860 to the accumulator piston 820 to be stored for later refill of the hydraulic circuit. Pressurized hydraulic fluid in the slave piston bore 304 escapes through the accumulator vent passage 860 and allows the slave piston 340 to move upward relative to the downward motion of the valve bridge 300 until the slave piston 340 resets against the end wall of the slave piston bore 304. The main exhaust event may then be completed by the valve bridge 300 acting on each of the engine valves 400 and 410 mechanically, as explained below.

No significant amount of hydraulic fluid may escape through the accumulator vent passage 860 during the initial part of the compression-release event because the accumulator vent passage remains sealed during this time. The small opening of the engine valve 400 by the slave piston 340 may produce compression-release type engine braking. The braking load over the slave piston 340 during the compression stroke of the engine cylinder may be transferred to the brake load screw 510 through the hydraulic fluid pressure in the slave piston bore 304. As a result, the braking load need not be transferred back through the valve train to the master piston 320, the rocker arm 200, or the cam 100.

The cam 100 continues to rotate through the compression-release event during engine braking operation until the main exhaust lobe 120 reaches the cam roller 210 causing the rocker arm to pivot beyond the displacement produced by the compression-release lobe 130. The downward displacement of rocker arm 200 against the master piston 320 may no longer be hydraulically transferred to the slave piston 340 because the master piston may be contacting the end wall of the master piston bore 302. As a result, the downward displacement of the rocker arm 200 from the main exhaust lobe 120 may be transmitted mechanically from the master piston 320 to the valve bridge 300, which in turn may translate downward and open the first and second engine valves 400 and 410 for the main exhaust event.

The first engine valve 400 is already open when the second engine valve 410 first begins to open for the main exhaust event. As the valve bridge 300 moves downward for the main exhaust event it may pull away from the brake load screw 510.

After the main exhaust lobe 120 reaches its maximum height, the rocker arm 200 pivots clock-wise until the cam roller 210 is contacting the base circle of the cam. As the rocker arm pivots back during the later portion of the main exhaust event, the engine valves may close against their seats and the valve bridge 300 may come to a rest. Thereafter hydraulic fluid may force the master piston 320 upward again to refill the master piston bore 302 so that the cycle of compression-release braking and main exhaust valve actuation is repeated as describe above. Fluid for refill may come in part from the accumulator past the check valve 850.

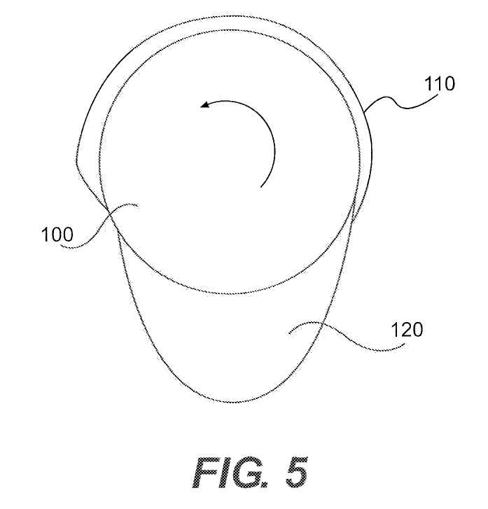

With reference to FIG. 5, in an alternative embodiment to that shown in FIG. 2, the cam 100 may be provided with a main exhaust lobe 120 and a partial bleeder braking lobe 110. The system may operate as explained above, but provide partial bleeder braking instead of compression-release braking.

While this invention has been described in conjunction with specific embodiments thereof, it is evident that many alternatives, modifications and variations will be apparent to those skilled in the art. For example, the shape, size and to some extent the configuration of the master and slave pistons, the cams and cam lobes, the rocker arm, the valve bridge and the control valve may be varied without departing from the intended spirit and scope of the invention. Furthermore, it is appreciated that the cam may be operatively connected to a rocker arm by directly contacting it or through any number of intervening valve train elements, including but not limited to push tubes, levers, or hydraulic systems. Still further, the use of springs in the foregoing embodiments should be considered to be illustrative of the use of any means for biasing two members towards and away from each other. Accordingly, the preferred embodiments of the invention as set forth herein are intended to be illustrative only and not limiting so long as the variations thereof come within the scope of the appended claims and their equivalents.

What is claimed is:

1. A system for providing compression-release engine braking, comprising:
a cam having a main exhaust lobe and a compression-release lobe;
a rocker arm operatively connected to the cam, said rocker arm including an internal rocker passage;
a valve bridge having a central portion positioned adjacent to the rocker arm, and having first and second ends operatively connected to first and second engine valves, respectively;
a slave piston incorporated into the first end of the valve bridge; and
a master piston incorporated into the central portion of the valve bridge.

2. The system of claim 1 further comprising a means for biasing the rocker arm towards the valve bridge.

3. The system of claim 2 wherein the means for biasing the rocker arm comprises a spring.

4. The system of claim 3 further comprising:
a valve bridge passage extending between the master piston and the slave piston, said valve bridge passage hydraulically communicating with the rocker passage; and
a first check valve disposed between the master piston and the slave piston.

5. The system of claim 4, further comprising a second check valve disposed between the master piston and the slave piston.

6. The system of claim 5, further comprising:
a slave piston bore provided in the first end of the valve bridge in which said slave piston is disposed;
a bleed hole extending from the slave piston bore to an outer surface of the valve bridge; and
a brake load screw positioned adjacent to the bleed hole.

7. The system of claim 6, further comprising a cam inner base circle portion between the main exhaust lobe and the compression-release lobe.

8. The system of claim 6, further comprising an elephant foot disposed between the rocker arm and the valve bridge.

9. The system of claim 8, further comprising a master piston bore provided in the central portion of the valve bridge, said master piston bore having an end wall,
wherein the master piston is slidably disposed in the mater piston bore, and
wherein the master piston is selectively sized to contact the master piston end wall when the rocker arm is actuated by the main exhaust lobe.

10. The system of claim 8 further comprising a means for stopping the slave piston from extending out of the slave piston bore more than a preselected distance.

11. The system of claim 1 further comprising:
a valve bridge passage extending between the master piston and the slave piston, said valve bridge passage hydraulically communicating with the rocker passage; and
a first check valve disposed in the valve bridge passage between the master piston and the slave piston.

12. The system of claim 11, further comprising a second check valve disposed in the valve bridge passage between the master piston and the slave piston.

13. The system of claim 1, further comprising:
a slave piston bore provided in the first end of the valve bridge;
a bleed hole extending from the slave piston bore to an outer surface of the valve bridge; and
a brake load screw adapted to selectively block the bleed hole.

14. The system of claim 1, further comprising a cam inner base circle portion between the main exhaust lobe and the partial bleeder lobe.

15. The system of claim 1, further comprising an elephant foot disposed between the rocker arm and the valve bridge.

16. The system of claim 1, further comprising a master piston bore provided in the central portion of the valve bridge, said master piston bore having an end wall,
wherein the master piston is slidably disposed in the mater piston bore, and
wherein the master piston is selectively sized to contact the master piston end wall when the rocker arm is actuated by the main exhaust lobe.

17. The system of claim 1, further comprising a slave piston bore provided in the first end of the valve bridge,
wherein the slave piston is slidably disposed in the slave piston bore, and
wherein the system further comprises a means for stopping the slave piston from extending out of the slave piston bore more than a preselected distance.

18. The system of claim 1 further comprising a means for supplying hydraulic fluid to the rocker passage.

19. A system for providing compression-release engine braking operation in an internal combustion engine, comprising:
a cam including a compression-release lobe;
a valve bridge operatively connected to the cam, said valve bridge having first and second ends operatively connected to first and second engine valves, respectively;
a slave piston slidably disposed in a slave piston bore incorporated into the first end of the valve bridge;
a master piston incorporated into the central portion of the valve bridge;
a bleed hole extending from the slave piston bore to an outer surface of the valve bridge; and
a means for selectively blocking the bleed hole.

20. The system of claim 19 further comprising a rocker arm operatively connecting the cam to the valve bridge.

21. The system of claim 19 further comprising at least one check valve disposed in a bridge passage extending between the slave piston and the master piston.

22. The system of claim 19 wherein the means for selectively blocking the bleed hole comprises a brake load screw mounted adjacent to the outer surface of the valve bridge near the bleed hole.

23. The system of claim 1 further comprising:
an accumulator bore provided in the valve bridge;
a hydraulic passage extending between the accumulator bore and the master piston;
an accumulator piston slidably disposed in the accumulator bore; and
an accumulator spring biasing the accumulator piston into the accumulator bore.

24. The system of claim 23 further comprising a check valve disposed in the hydraulic passage.

25. The system of claims 24 further comprising a reaction bolt disposed above the valve bridge above said slave piston, wherein the reaction bolt is adapted to make selective contact with the valve bridge.

26. The system of claims 23 wherein an axis along which the accumulator piston is slidable is substantially perpendicular to an axis along which the master piston is slidable.

27. The system of claims 23 further comprising:
a control valve bore provided in the rocker arm;
a control valve piston slidably disposed in the control valve bore; and
a control valve spring biasing the control valve piston into the control valve bore.

28. A system for providing partial bleeder engine braking, comprising:
a cam having a main exhaust lobe and a partial bleeder braking lobe;
a rocker arm operatively connected to the cam, said rocker arm including an internal rocker passage;
a valve bridge having a central portion positioned adjacent to the rocker arm, and having first and second ends operatively connected to first and second engine valves, respectively;
a slave piston incorporated into the first end of the valve bridge;
a master piston incorporated into the central portion of the valve bridge;
an accumulator bore provided in the valve bridge;
a hydraulic passage extending between the accumulator bore and the master piston;
an accumulator piston slidably disposed in the accumulator bore; and
an accumulator spring biasing the accumulator piston into the accumulator bore.

29. The system of claim 28 further comprising a check valve disposed in the hydraulic passage.

30. The system of claims 29 further comprising a reaction bolt disposed above the valve bridge above said slave piston, wherein the reaction bolt is adapted to make selective contact with the valve bridge.

31. The system of claims 28 wherein an axis along which the accumulator piston is slidable is substantially perpendicular to an axis along which the master piston is slidable.

32. The system of claims 28 further comprising:
a control valve bore provided in the rocker arm;
a control valve piston slidably disposed in the control valve bore; and
a control valve spring biasing the control valve piston into the control valve bore.
